(19) United States
(12) Patent Application Publication
(10) Pub. No.: US 2009/0139797 A1
(43) Pub. Date: Jun. 4, 2009

(54) Devices and methods for slowing descent

(76) Inventors: Jahangir S. Rastegar, Stony Brook, NY (US); Thomas Splnelli, East Northport, NY (US)

Correspondence Address: Thomas Spinelli, 2 Sipala Court, East Northport, NY, 11731, US

(21) Appl. No.: 11/998,924

(22) Filed: Dec. 3, 2007

(51) Int. Cl. A62B 1/20

(52) U.S. Cl. 182/5

(57) ABSTRACT

A method for decelerating a person during a descent. The method comprising: extending an elongated member from a first elevated point to a second point below the first point in the direction of gravity; movably attaching a person to the elongated member; and converting a kinetic energy of the person into potential energy to thereby decelerate the person.

### BACKGROUND OF THE INVENTION

1. Field of the Invention

The present invention relates generally to devices for slowing a descent and, more particularly, to rapid evacuation devices for fire-escape.

2. Prior Art

In case of fire inside a building, fire-escape ladders that are installed outside but attached to the building or staircases that are accessed by fireproof doors and protected from fire usually provide the occupants an escape route. The existing escape routes are, however, not always free of smoke and/or fire, and a section of it may have been damaged during the fire or an explosion. In some cases, a midsection of a building may have been damaged, making it impassable to those in the upper floors. In other situations, some of the occupants may have been trapped in one side of a floor with the path to the fire-escape ladders or staircases either physically blocked due to debris or by fire or usually very high temperature smoke. In a crowded building, even if the occupants have safe access to the fire-escapes, particularly for the case of a tall building, the process of evacuation is slow and dangerous due to possible panic by some of the occupants; the flow of the evacuating crowd hampers access by firefighters to the upper levels; and when the possibility of building collapse exists, there may not be enough time to evacuate all the occupants and for the emergency personnel to quickly evacuate the building. The evacuation of the occupants who are sick or weak or unable to walk is particularly difficult during an emergency.

Even in the case of buildings or the lower floors of a taller buildings where the firemen ladders could reach the occupants at certain windows or balconies or other exit points, the evacuation process is very slow, and the occupants have to be carried down one by one, in some cases after having been secured by a harness. In certain situations, the occupant and the firemen have to go up the ladder through smoke or in the worst case a segment overrun by fire, a task that may be impossible or endanger the life of the firemen and the occupant being evacuated since they cannot pass through the affected segment very quickly.

A need therefore exist for methods and devices of rapid evacuation of occupants from buildings subjected to fire, particularly for taller buildings and when the fire-escape routes or a midsection of it is made impassable by fire, smoke or physical damage.

A need also exists for methods and devices of rapid evacuation of occupants of a building on fire by firemen using ladders to make it possible to evacuate a relatively large number of people, particularly those who have problem walking or climbing down a ladder on their own; if a portion of the ladder is engulfed in fire or smoke; if the occupants have to be rescued from considerable heights, particularly in a windy condition.

### SUMMARY OF THE INVENTION

An objective of the present invention is to provide methods and devices of descent, such as a rapid evacuation of occupants of buildings on fire. Such means of rapid evacuation of occupants from a building on fire, hereafter referred to as “rapid fire-escape,” are preferably capable of being readily deployed from a location on the building or from a fireman ladder, are safe, are simple to use by either the firemen or the occupants with minimal training. The method and the means of rapid evacuation are highly desirable to be applicable to buildings with as few as two levels to skyscrapers with tens and sometimes over hundred stories. It is also highly desirable for a rapid fire-escape to be capable of evacuating occupants through segments engulfed with smoke and low intensity fire. The rapid fire-escapes must also be usable for both adults and children, and may not require any effort or operation by the user once the descent process has begun, so that a user could not block the use of the fire-escape to others due to the inability to perform a required task due to panic, physical disability or weakness or any other possible reason.

In addition, the methods and devices of descent, are also applicable to non-fire situations, such as evacuation of rock climbers from a cliff, of a tree-climber from a tree; a person who has climbed a power tower; or any other similar high points in which rescue crew deploys the rapid evacuation means from the top of a ladder or the high point itself. The rapid evacuation means may also be used to evacuate personnel or others from helicopters without requiring the helicopter to land. The rapid evacuation means may also be used to evacuate animals such as pets.

Accordingly, a device for decelerating a person during a descent is provided. The device comprising: an elongated member extending from a first elevated point to a second point below the first point in the direction of gravity; and an attachment assembly movably attached to the elongated member and having the person disposed thereon; wherein at least one of the elongated member and attachment assembly comprises a potential energy storage means for converting a kinetic energy of the attachment assembly into potential energy to thereby decelerate the attachment assembly and the person disposed thereon.

Also provided is a method for decelerating a person during a descent. The method comprising: extending an elongated member from a first elevated point to a second point below the first point in the direction of gravity; movably attaching a person to the elongated member; and converting a kinetic energy of the person into potential energy to thereby decelerate the person.

### BRIEF DESCRIPTION OF THE DRAWINGS

These and other features, aspects, and advantages of the apparatus of the present invention will become better understood with regard to the following description, appended claims, and accompanying drawings where:

FIG. 1 illustrates an overall schematic of a system for rapid descent from a building.

FIG. 2a1 illustrates a portion of a cable and a wedge-shaped element for use in the system of FIG. 1, FIG. 2a2 illustrates a cross-sectional view of the wedge-shaped element of FIG. 2a1 as taken along line 2a2-2a2 in FIG. 2a1.

FIG. 2b1 illustrates a portion of a cable and a variation of the wedge-shaped element for use in the system of FIG. 1, FIG. 2b2 illustrates a cross-sectional view of the wedge-shaped element of FIG. 2b1 as taken along line 2b2-2b2 in FIG. 2b1.

FIG. 2c1 illustrates a portion of a cable and a variation of the wedge-shaped element for use in the system of FIG. 1, FIG. 2c2 illustrates a cross-sectional view of the wedge-shaped element of FIG. 2c1 as taken along line 2c2-2c2 in FIG. 2c1.

FIG. 2d1 illustrates a portion of a cable and a variation of the wedge-shaped element for use in the system of FIG. 1, FIG. 2d2 illustrates a cross-sectional view of the wedge-shaped element of FIG. 2d1 as taken along line 2d2-2d2 in FIG. 2d1.

FIG. 2e1 illustrates a portion of a cable and a wedge-shaped element for use in the system of FIG. 1, FIG. 2e2 illustrates a cross-sectional view of the wedge-shaped element of FIG. 2e1 as taken along line 2e2-2e2 in FIG. 2e.

FIG. 2f1 illustrates a portion of a cable and a variation of the wedge-shaped element for use in the system of FIG. 1, FIG. 2f2 illustrates a cross-sectional view of the wedge-shaped element of FIG. 2f1 as taken along line 2f2-2f2 in FIG. 2f1.

FIG. 2g illustrates a portion of a cable and a variation of the wedge-shaped element for use in the system of FIG. 1.

FIG. 3 illustrates a portion of a cable and interior components of a wedge-shaped elements.

FIG. 4b illustrates a portion of a cable, an attachment assembly and person attached thereto of the system of FIG. 1, FIG. 4a illustrates an enlarged portion of FIG. 4b.

FIG. 5a illustrates a portion of a cable and FIG. 5b illustrates an enlarged portion of the cable assembly of FIG. 5a with an attachment assembly and person attached thereto.

FIG. 6 illustrates a sectional schematic of a viscous element used in the system of FIG. 1.

FIG. 7 illustrates a sectional schematic of a variation of the viscous element of FIG. 6.

FIG. 8 illustrates a path of cable through an attachment assembly of FIG. 1.

FIG. 9a illustrates a portion of a cable and FIG. 9b illustrates an enlarged portion of the cable assembly of FIG. 5a with an attachment assembly and person attached thereto.

FIG. 10 illustrates an alternative cable assembly of FIG. 9a.

FIG. 11a illustrates a portion of a cable and FIG. 11b illustrates an enlarged portion of the cable assembly of FIG. 11a with an attachment assembly and person attached thereto.

FIGS. 12a and 12b illustrate alternative attachment assemblies.

### DETAILED DESCRIPTION OF THE PREFERRED EMBODIMENT

Although the present invention is applicable to numerous applications, it is particularly useful in the environment of providing a rapid evacuation from a building. Therefore, without limiting the applicability of the present invention to providing a rapid evacuation from a building, it will be described in such environment. As discussed above, the methods and devices disclosed herein have other applications, such as evacuation of rock climbers from a cliff, of a tree-climber from a tree; a person who has climbed a power tower; or any other similar high points in which rescue crew deploys the rapid evacuation means from the top of a ladder or the high point itself, to evacuate personnel or others from helicopters without requiring the helicopter to land and may be used to evacuate animals such as pets.

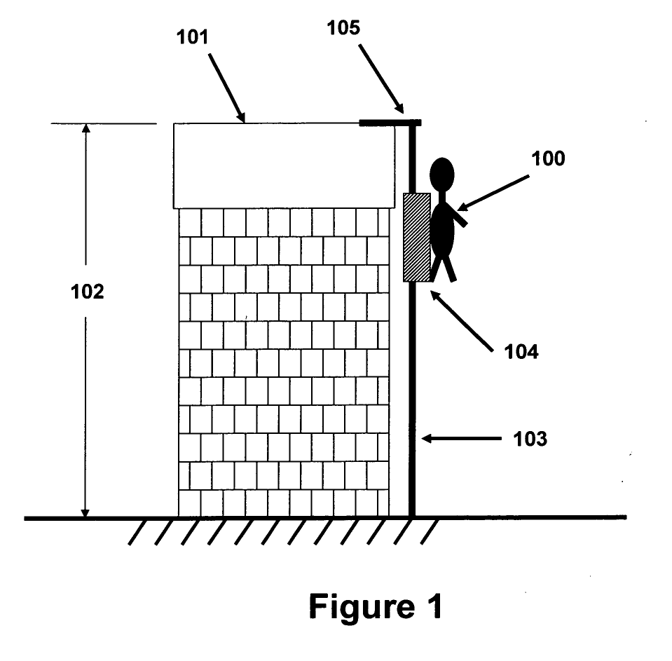

The following methods to achieve rapid but controlled descent from a height are disclosed. One method is described with reference to the schematic of FIG. 1. In this illustration, a person 100 is to descend from a building 101, from a height 102. The means of descent 103, in this schematic shown as a simple cable assembly (with details of the assembly along the length of the cable not shown), is used to accomplish rapid but controlled descent. The means of descent 103 is attached to the building 101 by an attachment element 105. The means of descent can also be built in to the building as an architectural feature of the building. An attachment assembly 104 is firmly attached to the descending person 100. Alternatively, the person or multiple people can sit or stand in the attachment assembly. The attachment assembly 104 is then secured to the descent means 103. The person 100 is then allowed to descend along the descent means 103 via the assembly 104. The weight of the person 100 and the assembly 104 provides a downward force. The descent means 103 and the attachment assembly 104 are provided with the basic means consisting of elastic, viscous damping or dry friction elements, any number of which may have been combined and may be integral parts of the structure descent means 103 and/or the attachment assembly 104 (to be described below for each one of the disclosed methods) to control a speed of descent.

As the attachment assembly 104 and the person(s) 100 (or object or animal) to whom the assembly 104 is secured travels down the descent means 103, the potential energy of the descending mass is converted into kinetic energy. The function of the elastic elements is to absorb and store part of the above potential and/or kinetic energy. The potential energy stored in the elastic elements is preferably released in such a way that it is not returned back to the descending attachment assembly 104 and the person (object or animal) secured to it. The function of the viscous damping and dry friction elements is to convert part of the above kinetic and potential energy into heat. The viscous damping element may also be used to limit the speed of descent for various mass descending persons (objects or animals) and also provide the means to make the speed of descent more constant. The viscous damping and dry friction elements are preferably as close to being distributed uniformly along the length of engagement between the descent means 103 and the attachment assembly as possible, in order to make it possible to achieve close to constant or uniformly increasing or decreasing descent speed as possible. The speed of descend could also be made to be more constant by making the elastic characteristics more uniformly distributed along the length of the descent means 103 (when applicable) and along the mating length of the attachment assembly 104. When discrete elastic elements are used, they are preferably positioned as close as possible to each other along the applicable length of engagement between the descent means 103 and the attachment assembly 104, to provide a close to uniform distribution of elastic characteristics.

The embodiments, where possible, may be equipped with active controls to achieve the desired rate and pattern of descent. Such active means of control are particularly useful when people (objects or animals) with a wide range of weight are to use the descend system. Such active means may, for example, be deployed to vary the spring rates of the elastic elements, vary the viscous damping rates, vary the dry friction (braking) forces, or any of their combinations. The active elements are preferably controlled with feedback loops (preferably to achieve the desired pattern of descent rate). In general, however, to reduce complexity and to avoid problems with the electronics and the power source (considering the harsh environment of the system operation and the fact that the system is in general stored for a considerable number of years before possible use), the embodiments with passive elements are preferable.

The descent can start slowly, become faster before reaching a certain maximum speed. The descent can then be continued with a relatively constant velocity, and then slowed to a minimum landing speed near the terminal point (usually ground).

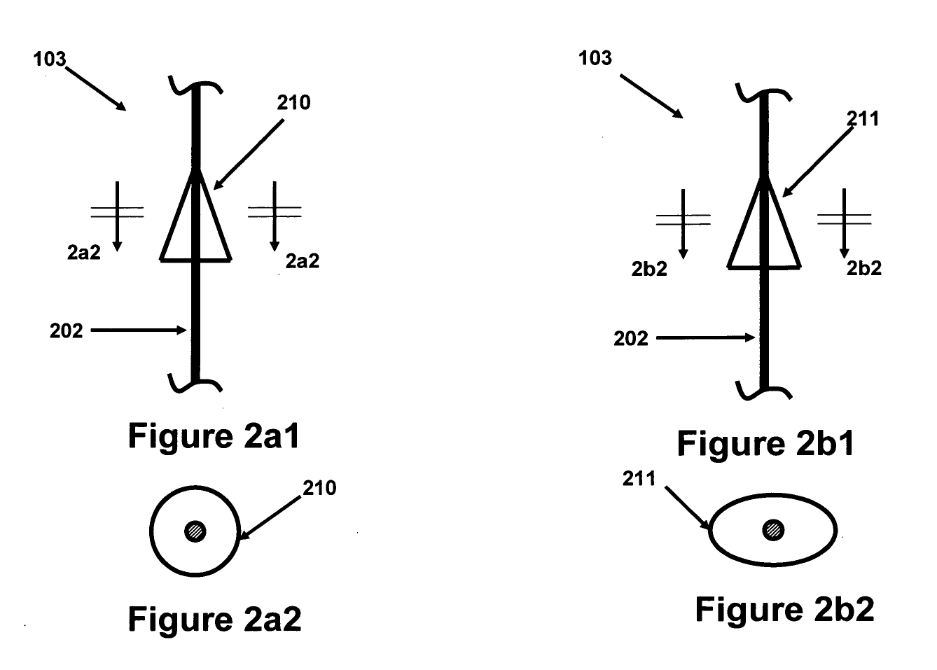

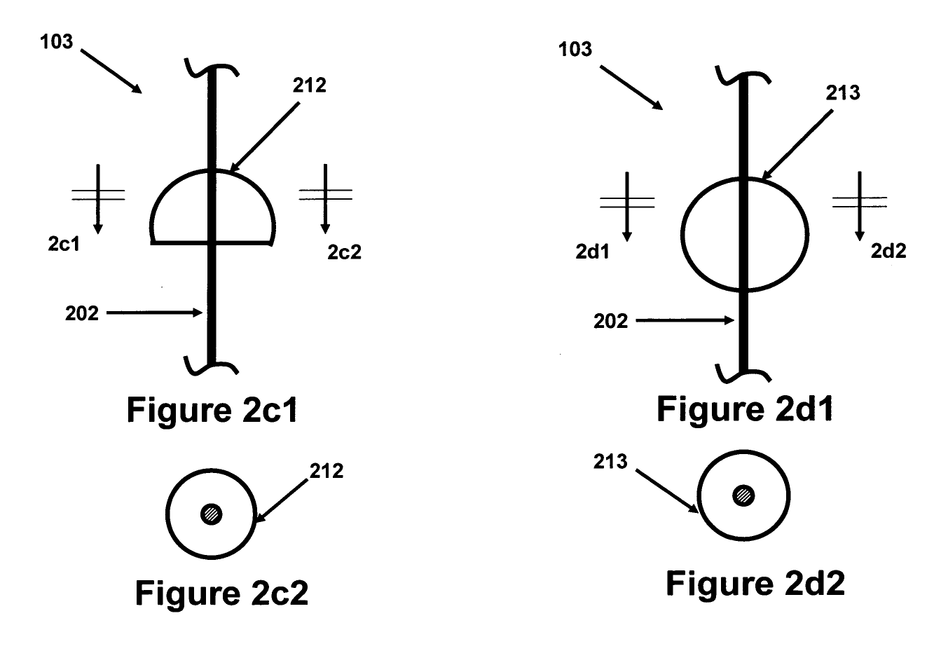

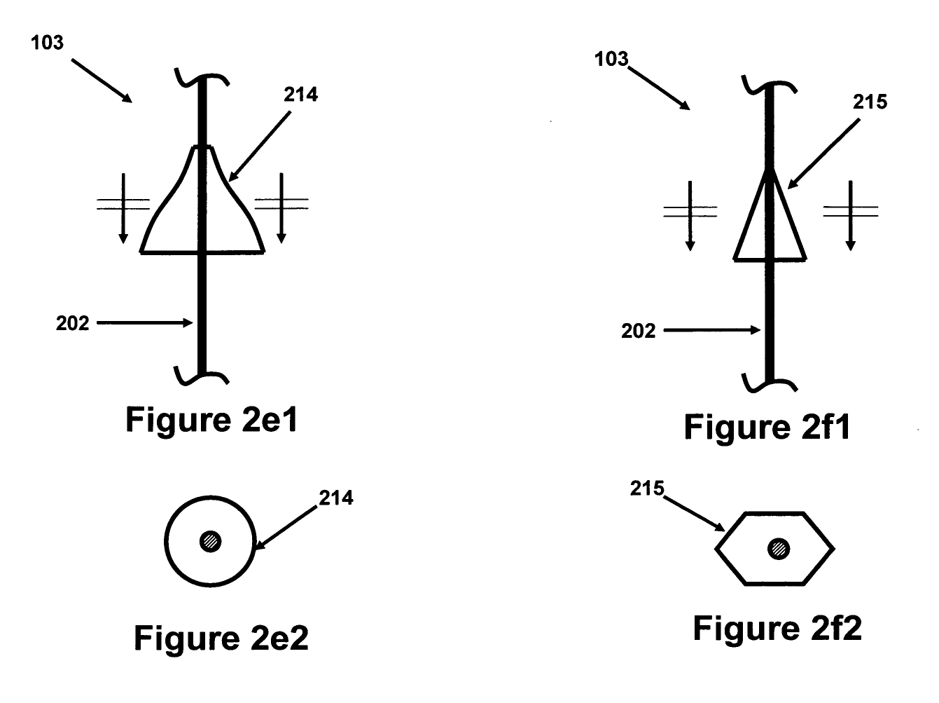

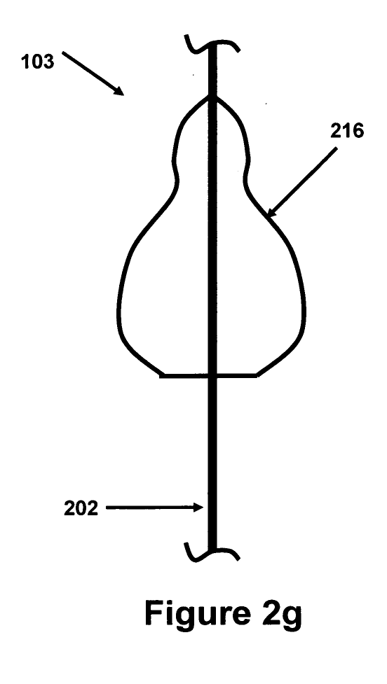

Referring now to FIGS. 2a1-2g, the cable assembly 103 can consist of “wedged-shaped” elements that are attached to a cable 202 along the length of the cable, with the narrower side of the “wedged-shaped” elements located on the top (at the higher height end of the cable) as shown in FIGS. 2a1-2g. The wedged-shaped elements are preferably symmetrical about the centrally attached cable, such as a cone 210 with a circular cross-section shown in FIGS. 2a1 and 2a2, a cone 211 with an oval cross-section shown in FIGS. 2b1 and 2b2, a semi-spherical shaped element 212 shown in FIGS. 2c1 and 2c2, a spherical shaped element 213 shown in FIGS. 2d1 and 2d2, a bell shaped element 214 shown in FIGS. 2e1 and 2e2, cone-shaped elements with polygon cross-section 215 shown in FIGS. 2f1 and 2f2 or any other similar shapes with several flat or curved surfaces, such as element 216 with a longitudinal cross-section shown in FIG. 2g.

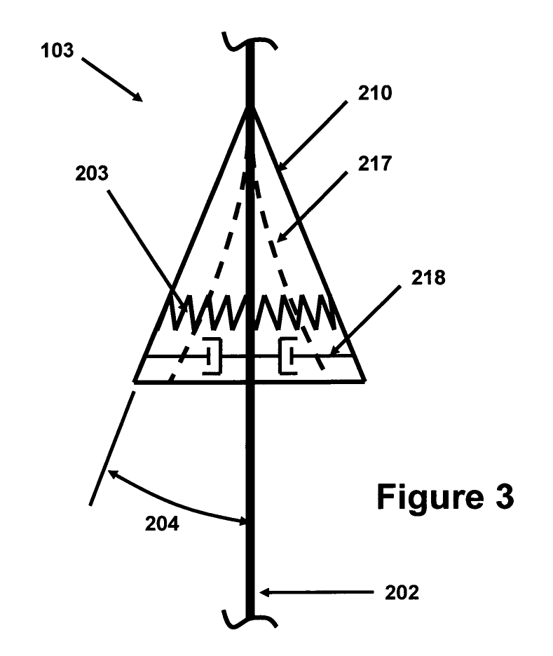

When using a curved surface, the surface may be concave, convex, or their combination and certain regions may even be flat. Hereinafter, the general characteristics and the functions of the wedged-shaped elements are going to be described in terms of cone-shaped element 210, noting that wedge-shaped elements with other geometries all perform the same functions. A cross section of a “cone-shaped” wedge-shaped element is shown in FIG. 3. The wedged-shaped elements may be provided with a certain amount of elasticity, either due to the geometry or material characteristics of its own structure, for example as shown in FIG. 3 with the sidewalls of the cone in the deflected position 217 (shown by broken lines), and/or by one or more spring elements 203, resisting the tendency to reduce the general wedging angle 204. The wedged-shaped elements 210 may also be provided with damping elements (not shown) of viscous or dry friction type or a combination of the two. The damping elements are preferably positioned in parallel with the spring elements, however, they may also be positioned in series with the spring elements or in any other combined configurations as long as they resist the speed of reduction in the general wedge angle 204. The structure of the wedged-shaped elements 201 may also be made of materials with certain amount of internal damping. In the embodiment of FIG. 3, a mechanical spring element is shown; however, any other type of spring element, such as pneumatic, hydraulic, etc., may also be used. The elastic and the damping elements may also be combined, for example, viscoelastic materials may be used to construct elements with the desired elastic and damping characteristics. Before descent, the attachment assembly 104 is secured to the descending person (animal or object) 100, for example, by some type of harness. As discussed above, the person or persons may also sit in or on or even stand on or in the attachment assembly, each using a seat belt, harness or other means to secure themselves from falling. Such attachment means are well known in the art, particularly in the field of amusement park rides.

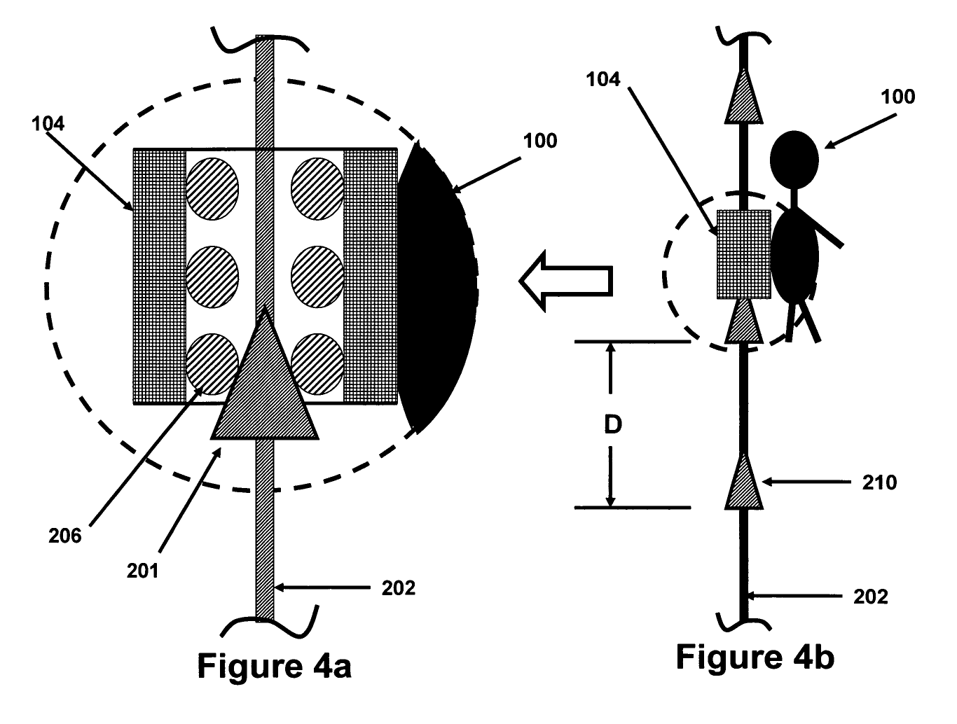

The attachment assembly is then mounted over the cable assembly 103, by passing the cable 202 through the attachment assembly 104, which is provided with one or more elements 206 that engages the wedged-shaped elements 201 as the attachment assembly 104 together with the person 100 who is attached to it, travel down the cable assembly 103, FIGS. 4a-4b (the longitudinal cross-section of the attachment assembly is shown in the blow-up of FIG. 4b). The elements 206 may have varieties of shapes and geometries, and are shown as circular toroidally shape in FIG. 4a to allow describing its function. In general, a large number of wedged-shaped elements 201 and elements 206 are positioned along a relatively long attachment assembly to provide a relatively smooth descent.

The elements 206 can be relatively rigid and the wedged-shaped elements 201 and are provided with a significant amount of elasticity and preferably viscous damping using the aforementioned methods, such as the cone elements shown in FIG. 3. Dry friction elements may also be provided, for example between the contacting surfaces between the wedged-shaped elements 201 and the elements 206, to smoothen the descending motion and dissipate certain portion of the potential energy of the descending person 100 (animal or object). During descent, as the wedged-shaped elements 201 reach a relatively rigid element 206, it is pressured to reduce its cone angle 204 (and/or size and/or shape for wedged-shaped elements of other shapes), as shown in FIG. 3, thereby transferring part of the potential of the descending mass (and if the spring rate of the wedged-shape element is relatively large such that the descent velocity is reduced, then part of the kinetic energy of the descending mass as well), as stored potential energy in the elastic elements of the wedged-shaped element 201. If the wedged-shaped element has viscous damping elements, then the rate of deformation (or displacement) of the viscous damping elements result in the transformation of part of the kinetic energy of the descending mass into heat. In the presence of dry friction (braking) elements, then part of the kinetic energy of the descending element (the person 100 and the attachment assembly 104) is dissipated by the braking force (as heat and wear). In general, it is desired to have as many wedged-shaped elements 201 along the cable 202 as possible to make the speed of descent as smooth as possible. The number of wedged-shaped elements 201 for any given linear length of cable 202 can be varied along the length of the cable to control the descent speed (e.g., more can be used at the bottom, near the terminal, so as to slow the attachment assembly 104 for disenbarkment). For a distance D (see FIG. 4b) between two consecutive wedged-shaped elements 201, if the total energy potential and kinetic energy transferred from the descending element (the person 100 and the attachment assembly 104) to the elastic (spring) elements 103 in the form of potential energy and to the viscous damping and braking elements (dry friction) in the form of heat and all other energy losses (such as aerodynamic losses) is greater than the potential energy MD, where M is the total mass of the descending element (the person 100 and the attachment assembly 104), then the person 100 (together with the attachment assembly 104) is slowed down in its downward (descending) motion. Otherwise, the speed of descent is increased. The speed of descent stays nearly constant if the two energies are nearly equal. In practice, the descent means 103 is preferably assembled such that the descending person is initially accelerated relatively slowly to certain velocity, then travels at relatively constant speed, and then decelerated slowly to a slow speed, which is safe for landing depending on the conditions of the landing site and the presence of cushioning elements.

Alternatively, the wedged-shaped elements 201 can be relatively rigid in which case the elements 206 can be provided with a significant amount of elasticity and preferably viscous damping using the aforementioned methods. Dry friction elements may also be provided to smoothen the descending motion and dissipate a certain portion of the potential energy of the descending person (animal or object). This embodiment operates in a manner similar to that of the previous embodiment, with the difference being that the potential and kinetic energy of the descending element (the person 100 and the attachment assembly 104) is transferred to the elastic elements, viscous damping and dry friction elements embodied in element 206 (not shown in FIG. 4a). A number of such configurations are described below. In such an embodiment, during the descent, the potential energy of the descending element (the person 100 and the attachment assembly 104) is mostly transferred to the elements 206 and the attachment assembly 104 as heat. These components must therefore be provided with the means to distribute and dissipate heat to keep temperatures within a manageable range, particularly for relatively tall buildings.

As another alternative, the wedged-shaped elements 201 and the elements 206 can both be provided with a significant amount of elasticity and preferably viscous damping using the aforementioned methods. Dry friction elements may also be provided to smoothen the descending motion and dissipate a certain portion of the potential energy of the descending person (animal or object). The dry friction is preferably provided between the contacting surfaces of the wedged-shaped elements and the elements 206.

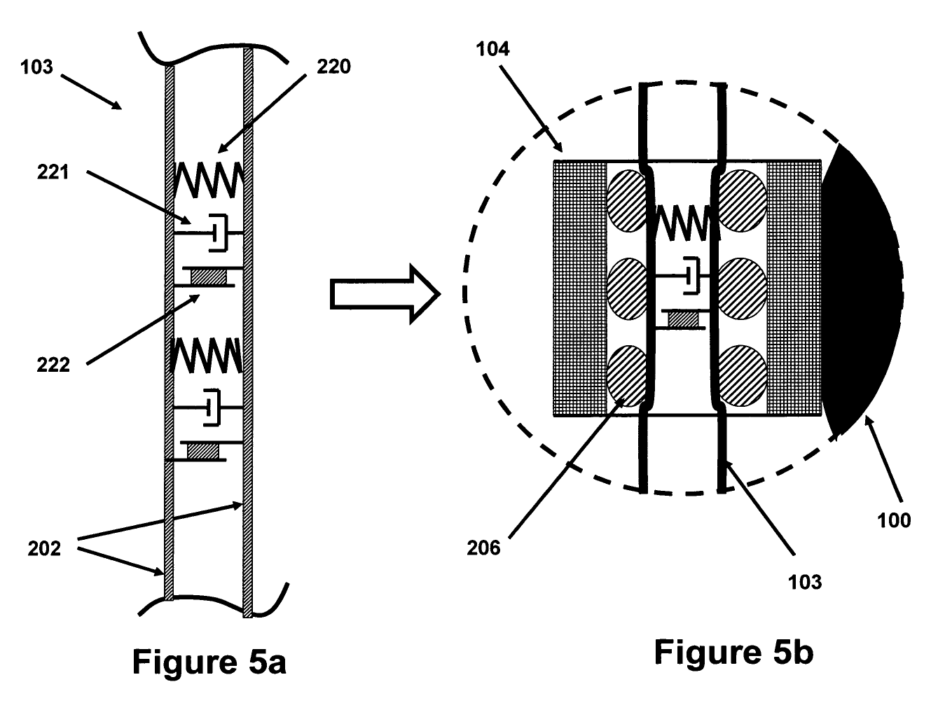

In such a method, the cable assembly 103 can consist of two or more cables 202 as shown in FIG. 5a. The cables are attached to each other with elastic elements 220, and/or the viscous damping elements 221, and/or dry friction type of elements 222, preferably elements constructed with viscoelastic materials such as rubber or other similar synthetic materials in combination with certain structural elements such as metal or other lightweight but strong materials for attaching them to the cables 202. The attachment assembly 104 can also be provided with relatively rigid elements 206 (as sown in FIG. 5b), with an inner opening that is smaller than the width of the cable assembly. During descent, the cables are pressed towards each other, thereby pressurizing the elastic elements in between and deforming (providing relative displacement in) the viscous damping and/or providing relative displacements at the dry friction elements, FIG. 5b. As a result, the kinetic and/or potential energy of the descending person 100 and the attachment assembly are transferred to the elastic elements as potential energy and to the viscous damping and/or dry friction elements as heat. The potential energy stored in the aforementioned elastic elements must be prevented from being transferred back to the descending mass by either releasing it as described for the previous embodiments or by controlling the rate at which the elastic elements return to their original state with the viscous damping elements. Viscous damping elements (preferably constructed at least partly by viscoelastic materials) can be used in this embodiment since they provide a means to limit the speed of descent if a heavier than expected person (object or animal) uses the system to descend. The two or more cables may also be provided with wedged-shaped elements similar to those shown in FIGS. 2a-2g to achieve the aforementioned displacement (deformation) of the elastic, viscous damping and dry friction elements.

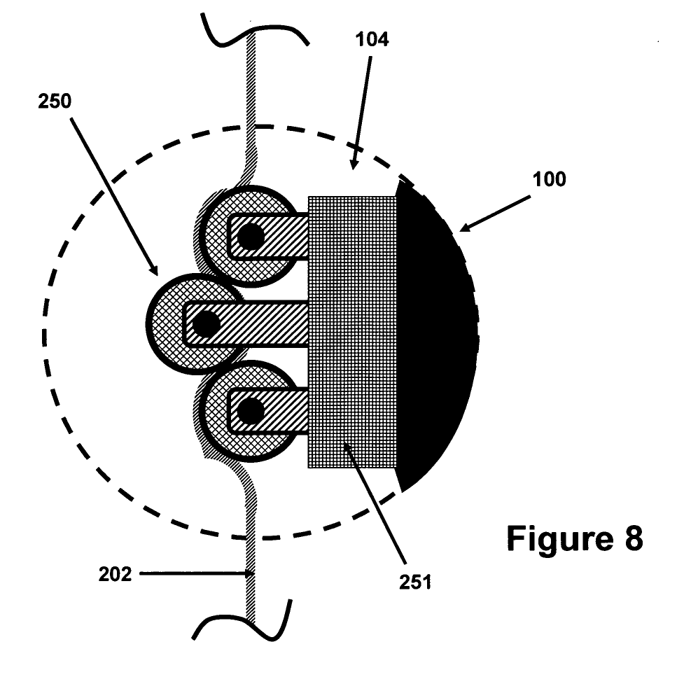

In this method, at least one cable 202 is used and the attachment assembly 104 is equipped primarily with a dry friction element (braking element) that operates against one or more cables 202 or some intermediate element. The cable(s) can pass through at least one or more than two, bent (wavy) sections to increase the friction contact forces. Such an arrangement is shown in FIG. 8, with the pulleys 250 providing the “wavy” section (considering that the pulleys 250 are fixed to the structure 251 of the attachment assembly 104, with the friction pads located on the surface of the pulleys 250). In an embodiment, the attachment assembly can be designed such that the weight of the descending person (object or animal) automatically adjusts the contact forces to achieve the desired speed of descent by increasing the contact forces with increased weight of the descending mass. In another embodiment, the pulleys can be free to rotate and dry friction (braking) mechanisms or rotational viscous damping elements (not shown in FIG. 8) are provided as resistance to a rotational speed of the pulleys, thereby transforming at least part of the kinetic and/or potential energy of the descending mass to heat. In general, viscous damping elements can be used since they provide a means to control the speed of descent for different descending masses.

In this method, the means of controlling the speed of descent, i.e., the means of absorbing the kinetic and potential energy of the descending person 100 and the attachment assembly 104, is almost entirely based on viscous damping. In one embodiment, the viscous damping is provided by viscous dampers of the commonly used type, i.e., those based on pistons or the like pushing a viscous fluid though an orifice. The viscous dampers may be attached to the cable assembly 103 (218 in FIG. 3), but are preferably attached to the attachment assembly 104 as elements 206. In an embodiment, the viscous elements can be designed to deform by one of the aforementioned wedged-shaped elements in such a way to cause the viscous fluid to circulate through an orifice or flow back and forth through an orifice between two or more chambers. The viscous damper elements (elements 206) can be provided with a certain amount of elastic characteristics to absorb part of the kinetic and/or potential energy of the descending mass and releasing it as the attachment assembly travels down the cable assembly 103. The following basic methods may be used to provide a cable assembly 103 and the attachment assembly 104 based viscous damping based rapid evacuation fire-escape devices.

The elements 206 of the attachment assembly can be relatively rigid and the viscous damper elements can be mounted on the cable assembly, for example as shown in FIG. 3 to the wedged-shaped elements (viscous damper elements 218). During descent, the elements 206 tend to displace (deform) the sides of the wedged-shaped elements, thereby displacing the viscous damping elements, thereby transforming part of the kinetic and/or potential energy of the descending mass to heat. The amount of energy transformed to heat by the damping elements is dependent on the speed of descent, increasing with increased speed of descent, thereby providing a means to control the speed of descent for different descending masses. The wedged-shaped elements are preferably also provided with elastic elements that store part of the kinetic and/or potential energy of the descending mass to potential energy and the means to release it after the descending mass has essentially passed the element (such as with the damping elements providing the required means of delayed release of the potential energy of the elastic elements).

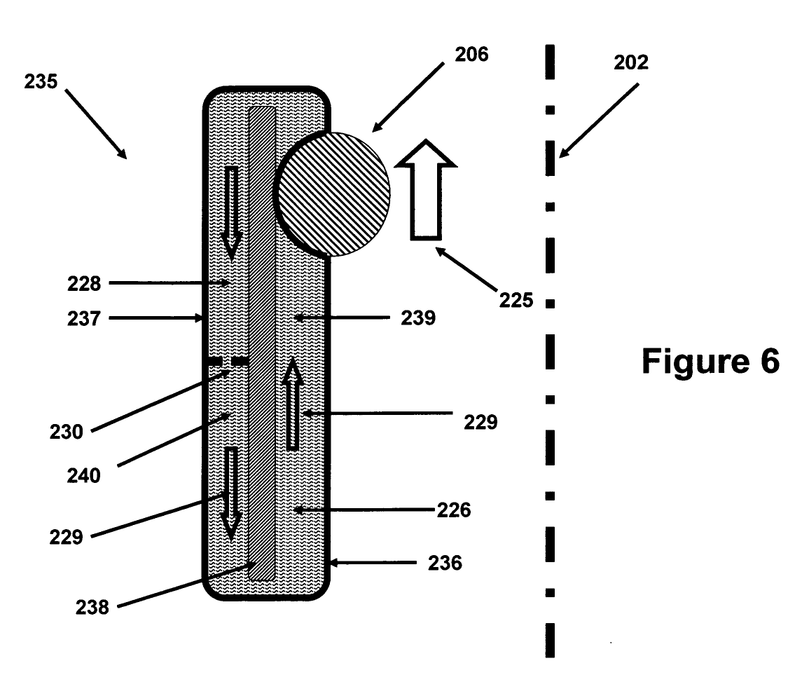

In another embodiment, viscous elements can be used with relatively rigid wedged-shaped elements 206, FIG. 6. The principles of operation of such viscous elements 235 with circulating viscous fluid can be described by the schematic of FIG. 6. In FIG. 6, half of a longitudinal cross-section of a closed cylindrical viscous element 235 consisting of an inner cylindrical wall 236 and an outer cylindrical wall 237 is shown. The closed space within the cylindrical viscous element 235 is divided by a wall 238 into an inner chamber 239 and an outer chamber 240. The two chambers are interconnected by the provided holes on the top and bottom of the chambers 239 and 240. In FIG. 6, a toroidal wedged-shaped element 206 is shown, however, any other type of wedged-shaped elements such as those shown in FIGS. 2a-2g may also be used. The toroidal wedged-shaped element 206 is fixed to one or more cables 202 (for the sake of simplicity, the connecting element is not shown and the cable(s) are shown as a broken center line). During descent, as the cylindrical viscous element 235 is forced down, the toroidal wedged-shaped element 206 compresses the inner chamber 239 to close at its extreme point of contact, and forces the viscous fluid to flow in the direction 229. The outer chamber 240 is, however, provided with at least one orifice that causes resistance to the nearly free flow of the viscous fluid, thereby causing the kinetic and/or the potential energy of the descending mass to be converted to heat. In another embodiment, the cylindrical viscous element 235 can consist of a single chamber with similar elastic inner wall 236 but an essentially rigid outer wall 237. Then during descent, the toroidal wedged-shaped element 206 compresses the wall 236 outward, nearly closing the passage at its extreme point of contact, forcing the fluid to pass through the developed “orifice” from the top of the chamber towards the bottom of the chamber. As a result, providing the means to transform the kinetic and/or the potential energy of the descending mass to heat.

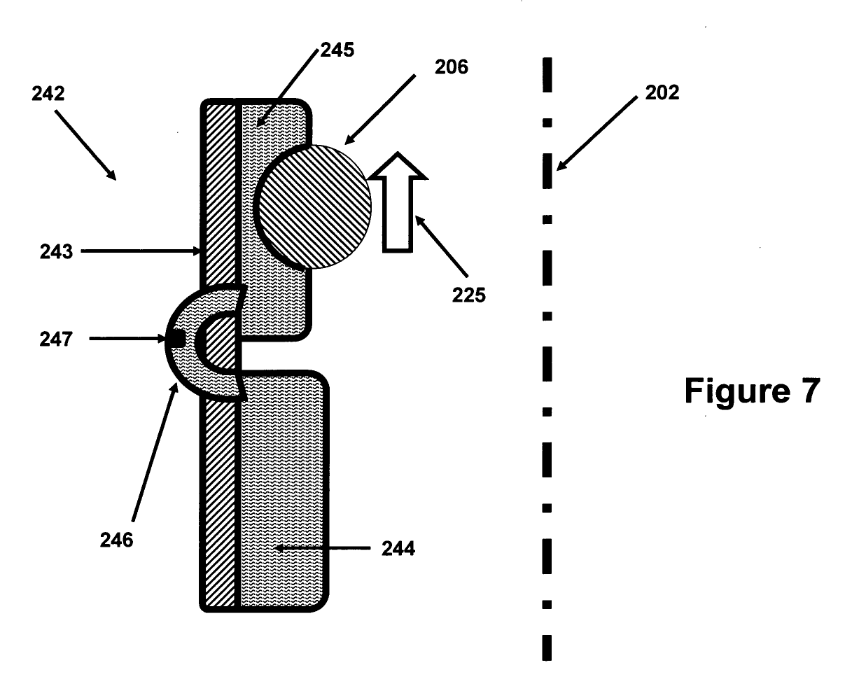

In another embodiment, viscous elements 242, can be designed to force the viscous fluid to make a back and forth flow through an orifice, FIG. 7. In this embodiment, relatively rigid wedged-shaped elements 206 are still used as shown FIG. 6. The principles of operation of a typical such viscous element can be described by the schematics of FIG. 7. The viscous element 242 consists of a relatively rigid wall 243, interior to which are mounted at least one lower element 244 constructed with flexible but relatively inextensible frontal surfaces and an upper element 245 with characteristics similar to that of element 244. The chambers 244 and 245 may be toroidal shape covering the entire surface of the cylindrical wall 243 or may be formed of a plurality of pairs of upper and lower chambers. Both chambers are filled with a viscous fluid. The top of the lower chamber 245 is interconnected at least at one location to the lower part of the upper chamber 244 by one or more channels 246, in which exist at least one orifice 247 to provide resistance to flow from one chamber 244 or 245 to the other chamber. During descent, the toroidal wedged-shaped element 206 compresses first the chamber 244, thereby forcing the viscous fluid contained in the chamber 244 into the chamber 245 through the orifice 247. As a result, at least part of the fluid contained in the chamber 244 is forced into the chamber 245. As descent continues, the toroidal wedged-shaped element 206 passes over the chamber 244 and begins to compress the chamber 245, thereby forcing the fluid back to the chamber 244 through the orifice 247. As a result, part of the kinetic and/or potential energy of the descending mass is transferred to heat to provide a means to control the speed of descend.

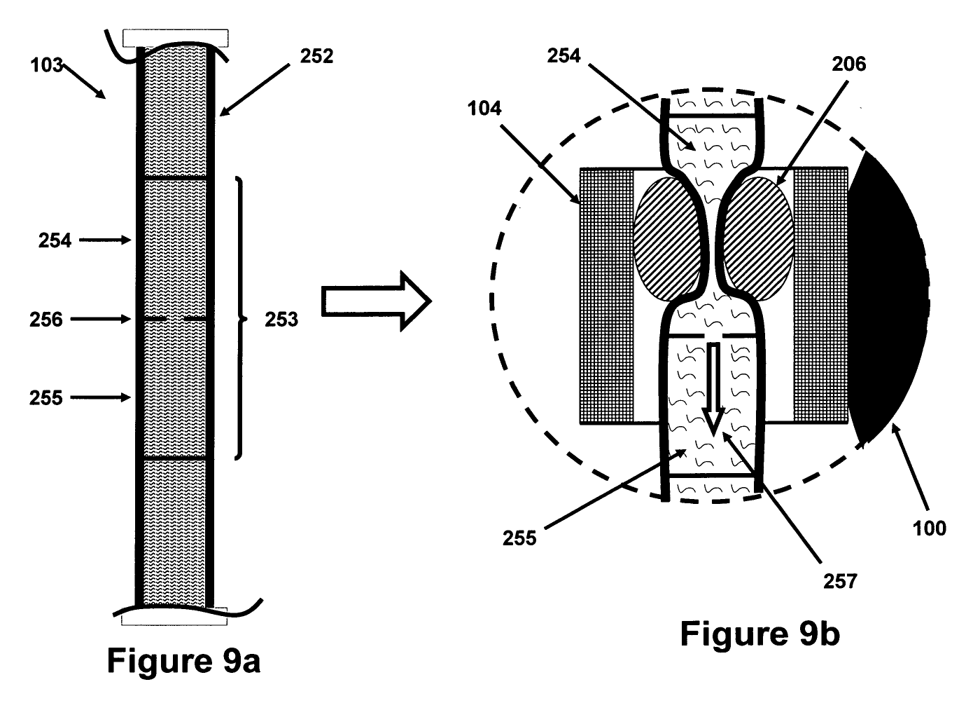

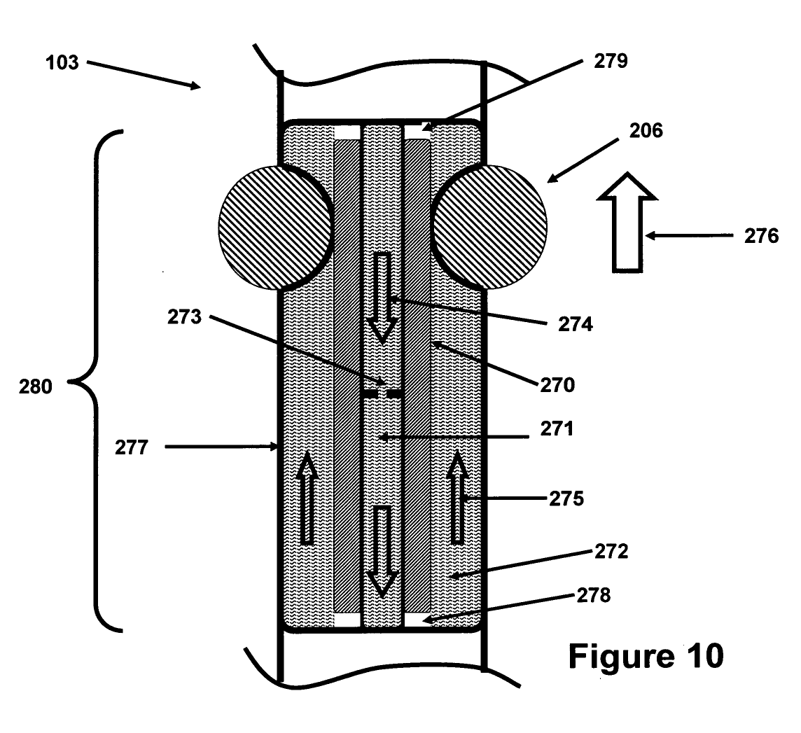

The viscous damping elements can be integral part of the cable assembly 103; otherwise, the system operates as described for the previous embodiment shown in FIGS. 4a-4b. The schematics of a typical such embodiment is shown in FIGS. 9a and 9b. In FIG. 9a, one design of the cable assembly 103 for such an embodiment is shown. In this embodiment, the cable assembly consists of a flexible but relatively inextensible tubular outer shell 252, which is preferably constructed with reinforcing fibers or the like for increased strength. The interior space of the shell 252 if divided into closed segments 253, consisting of two compartments 254 and 255, which are separated by at least one orifice and are filled with certain viscous fluid, preferably an inflammable and high temperature resistant and high viscosity fluid. During descent, the toroidal wedged-shaped element 206 compresses first the chamber 244, FIG. 9b, thereby forcing at least part of the viscous fluid contained in the chamber 255 into the chamber 254 through the orifice 256. As descent continues, the toroidal wedged-shaped element 206 passes over the chamber 255 and begins to compress the chamber 254, thereby forcing the fluid back into the chamber 255 through the orifice 256. Such chambers can be repeated along the length of the cable assembly 103, the size and configurations of which can vary over such length. As a result, part of the kinetic and/or potential energy of the descending mass is transferred to heat and the viscous flow through the orifice 256 to provide a means to control the speed of descend. It is appreciated by those familiar with the art, that instead of the back and forth flow described in FIGS. 9a and 9b, the cable assembly may also be designed to provide a circulating flow through an orifice similar to the one shown in FIG. 6. The schematics of a segment 280 of the cable assembly 103 of such design is shown in FIG. 10. Each segment 280 consists of a closed flexible but relatively inextensible tubular outer shell 277, which is preferably constructed with reinforcing fibers, mesh or the like for increased strength, and a concentrically positioned inner cylinder 270. The inner cylinder 270 is relatively flexible in bending but relatively rigid in the radial direction. The space between the two cylinders forms a chamber 272 and the interior space of the inner cylinder forms a chamber 271, which are filled with a viscous fluid (preferably of the type described above). Within the inner chamber 271, the orifice 273 is positioned to provide resistance to the flow of the viscous fluid. The two chambers 271 and 272 are interconnected at the top and at the bottom ends of the chambers by openings 279 and 278, respectively. During descent, the toroidal wedged-shaped element 206 travels in the direction 276 relative to the cable assembly 103, and compresses the shell 277 of the outer chamber 272, closing it at its extreme point of contact, and forces the viscous fluid to flow in the direction 274 inside the inner chamber 271 and through the orifice 273, and back into the chamber 271 in the direction shown by the arrow 275. The flow of the viscous fluid through the orifice 273 causes the kinetic and/or the potential energy of the descending mass to be converted to heat. The flow of the viscous fluid through the aforementioned orifice also provides the means to control the speed of descent for different descending masses.

In another embodiment, the outer chamber is not provided with the openings 278 and 279 into the inner chamber 271. The outer chamber 272 alone is filled with a viscous fluid. Then during descent, the toroidal wedged-shaped element 206 compresses the flexible walls of the outer shell 277, but leaves a small gap (or openings at a number of points) between the inside surface of the shell 277 and outside surface of the inner cylinder 270, which would serve as one or more orifices to resist the flow of the viscous fluid passes the toroidal wedged-shaped element 206.

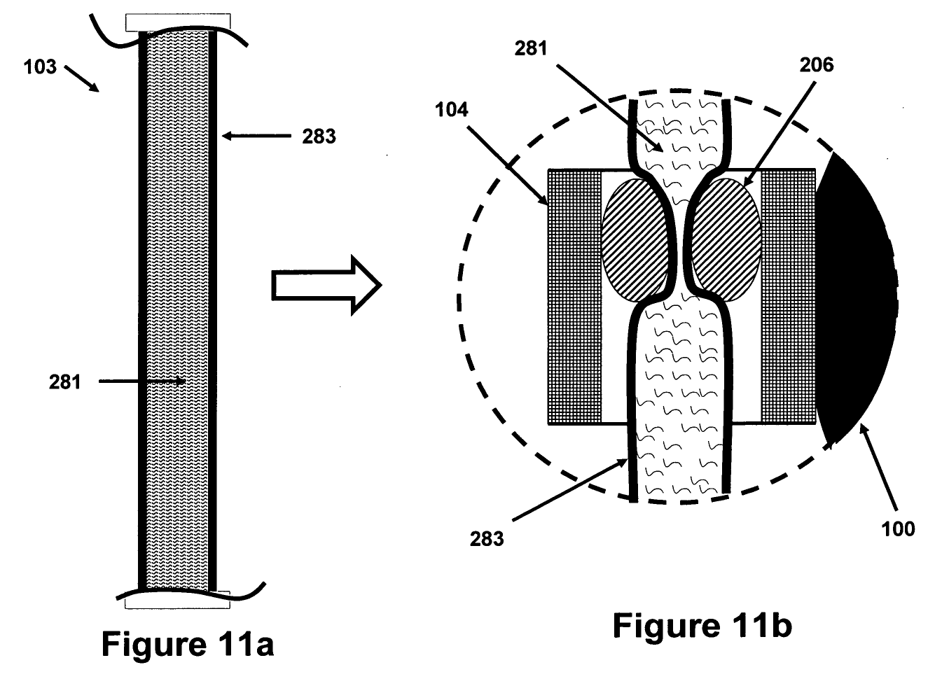

In yet another embodiment, the inner cylinder 270, FIG. 10, is not present and the entire resulting inner chamber 281 is filled with a viscoelastic solid such as soft synthetic rubber, FIG. 11. Then during descent, the toroidal wedged-shaped element 206 compresses the flexible walls of the outer shell 283 of the chamber 281, thereby deforming the viscoelastic material within at a rate related to the rate of descent, causing the kinetic and/or the potential energy of the descending mass to be converted to heat. The viscoelastic nature of the filling material also provides the means to control the speed of descent for different descending masses.

In this embodiment, one or more relatively rigid “rails” attached to one or more side or interior “shafts” of the building can be used in place of the cable assembly 103. The functional advantages of fixed shafts are that they essentially eliminate the cable assembly weight concerns, particularly for taller buildings, can withstand wind better, they are less subject to the limitations on the amount of descending mass, and that they can be used to better control the orientation and rotary motion of the descending mass. Before descent, the person 100 (object or animal) is secured to an attachment assembly 104.

An alternate embodiment like the previous cable types, is having the cable replaced by one or more rails. One main advantage of this embodiment is that it requires no deployment. They are also easier to use and should handle more people in a given time period. the main disadvantage is that it may have been damaged during fire or an explosion, thereby rendered useless.

In such embodiment, one or more “shafts” are provided in the building. A shaft may be located internal to the building or constructed on the sides of the building. The shafts preferably are constructed with no opening into the building except at its entrance points for the descending person (object or animal) and the landing area to minimize the chances of fire or smoke entering the shaft. The landing area is preferably within an area which is secure from fire and debris and that is easily accessible by the emergency personnel and other appropriate personnel and may have a damping unit, such as a large spring, at the end thereof to dampen the attachment assembly to a stop or near stop.

Alternate embodiments (U.S. Pat. No. 6,969,213 incorporated herein by its reference) include the damping and spring elements built either into the walls or the descending carriage. One main advantage of such an embodiment is that it requires no deployment. They are also easier to use and should handle more people in a given time period. The main disadvantage is that it may have been damaged during fire or an explosion, thereby rendered useless.

In this embodiment, a deployable cylindrical or other similarly shaped conduit (preferably a flexible and retractable) is first deployed from a certain location (a roof, balcony, window, a specially provided point of emergency exit or the like). In one embodiment, any one of the cable based devices can be deployed within the shut, which acts to protect the descending person from fire, smoke, etc. In another embodiment, the shut is equipped with the spring and/or damping elements, connected via panels to the shut.

During descent, the descending person can face the cable assembly. The attachment assembly can be provided with a “foot rest” and a handle for the person to hold during descent.

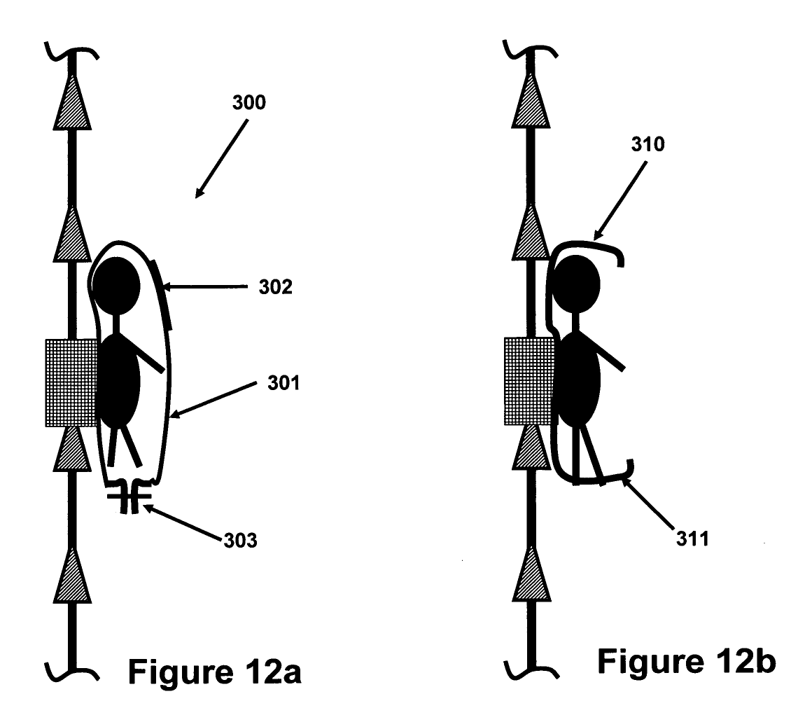

During descent, the person 100 (object or animal) may be provided with a cover assembly 300 for protection against fire, smoke and relatively small debris, FIG. 12a. In one embodiment, the person 100 is totally enclosed within the protective cover 301 with closing end 303, such as a zipper, preferably positioned where it is accessible to the descending person (in FIG. 12a, the closing end is shown positioned near the feet for ease of illustration only). The cover 301 may partially cover the person 100, particularly when there is no fear of intercepting fire or smoke to protect against debris or hitting some object or the walls. The cover is also preferably provided with a viewing portion 302 to allow the person to be physically aware of his/her position. The standing portion of the cover 300 is preferably made of shock absorbing (not shown) to soften landing and allow a relatively higher rate of descent than would be possible without it. The protective cover is preferably lightweight and wear resistant materials and may be constructed with materials with various degrees of resistance to fire. For buildings of relatively low heights, the time of descent is only a few seconds and the cover material only needs to have some resistance to fire. For such applications, natural fibers such as cotton treated for some resistance to fire and against smoke penetration is sufficient. For taller buildings where more time is going to be required for descent, more fire resistant and smoke impregnable cover, possibly with smoke filtering component can be used. Obviously, if no fire or smoke is present at the location of descent, then the descending person may not be required to use any such covers.

In another embodiment, the person 100 (object or animal) is provided with a protective frame (cage) 310, FIG. 12b. The protective cover can be attached to the interior of the frame 310, but may also be attached partially or wholly to the exterior of the frame 310. The primary function of the frame is to protect the descending person from impacting objects and/or if walls or tree branches, etc., are struck due to swinging action or the wind or any other reasons. The frame 310 is preferably padded and made of a lightweight material, which is fire and wear resistant. The frame 310 is preferably provided with a base 311 for the person to stand on. The base 311 is preferably attached to the base 311 with springs and in parallel friction (braking) or viscous damping elements (not shown) to absorb part of the force of impact during landing. In addition, the standing portion of the base 311 can be made of shock absorbing material (not shown) to soften landing. The spring and friction (damping) elements for base attachment and the soft standing portion have the functions of softening the landing as well as allowing relatively higher but safe rates of descent. The frame can also be provided with a set of two handles for the person to hold on (not shown). The longitudinal elements of the frame can also be formed with an outward curvature so that in case of overloading during impact, they buckle outward away from the descending person and also reduce the impulsive force of impact imparted on the person and absorb part of the kinetic energy of the descending mass.

For the case of taller buildings or buildings in which the cable cannot be deployed a short distance away from the walls or when wind is a problem or if landing cannot be made straight down due to the existence of certain obstructions or hazards or for any other reason, the lower end of the cable 202 can be fixed to the ground or a relatively heavy object such as a nearby rescue vehicle a certain distance away from the building in a safe landing area. When the present rescue system is provided for the building as a safety measure and not just at the time of fire, provisions are preferably made for a rapid attachment member and tension adjustment mechanism at an appropriate point with easy access by rescue vehicles and teams. In addition, in the landing area around the cable attachment member, landing cushions, preferably very thick and soft cushioning platform such as those constructed with air cushions cab also be provided for added safety, particularly when rescue from tall buildings or fireman ladders is being made and very rapid evacuation is desired. Other safety equipment such as nets may also be employed.

The attachment assembly may have a slotted longitudinal opening through which the cable could pass. The cable at the top can have a free segment for insertion into the slot, thereby mounting the assembly. Along the cable further down, the spheres (bells, etc,) are closely spaced, thereby preventing the assembly from being separated from the cable assembly (this works also for the rail type). Also, a safety lock (at least) on the top and bottom can further close to prevent the cable from coming out of the slot to provide for further safety.

Braking elements may be used instead or in combination with viscous damping elements or as a safety element to come in line if something goes wrong.

A self-adjusting mechanism to adjust the spring rate, and/or the damping rate, and/or the braking (friction) forces for various weight persons can also be used to compensate for greater/lesser weights and/or greater/lesser rates of descent.

The assembly 104 (or the cable itself) may be equipped with a locking mechanism that holds the assembly in place while the person is getting in position and secured to the assembly. A lever or the like is then pulled (by the operator or the person himself) or in any other similar fashion to release the locking mechanism.

The assembly 104 may be equipped with an adjustment mechanism for the person to adjust the rate of descent (preferably, the adjustment only adjusts the speed and cannot totally stop the assembly so that one person—for any reason, for example fear or accidentally or due lack of operational knowledge, etc.) could not halt the flow of people down the cable assembly. This could mean that only access to the spring element is advisable (for a limited change in the spring rate). The viscous damping rate adjustment may not be necessary since it cannot prevent the descending mass from getting stuck in the presence of too strong springs or braking forces.

The attachment assembly may be attached to a retrieval cord or wire with a collection spool so that when needed, they could be pulled back up for the next descent.

More than one cable 202 may be used and the spring/damper elements may be used to provide spacing, or one for braking and the other for the wedge-shaped element attachment or any other combination.

Furthermore, even during constant speed descent, the elastic elements can be deformed in cycles of accelerations and deceleration, thereby providing dynamic contact forces, which in turn could be used to provide friction forces. The contact forces increase with speed of descent, thereby providing another speed limiting factor.

Dynamic force and the resulting friction (braking) forces and/or the transferred kinetic energy to the accelerated elements (inertia elements—for example an inertia wheel) may also be used (alone or with other means of speed control/energy transfer) to provide the means for controlling the speed of decent.

Elastic elements for the lowest expected descending mass with viscous dampers to control the speed for different descending masses (may use the energy to vibrate a resonating mass at relatively high frequencies to increase the energy transferred to heat by the viscous elements) can also be used.

The entire rapid evacuation system can be packaged in a container that may have other functions, e.g., a box-like seat in front of the window, in which the cable assembly and a number of attachment assemblies, and when needed an offset structure and platform for keeping the user away from the walls are stored. The box and/or the cable assembly can be anchored to the structure of the building. To deploy the system, the box is opened, the offset structure is deployed and then the cable is dropped down. The system can have a standing platform for safe loading of the descending individuals.

A telescopic window bar can be opened and set across the window to serve as an anchor and provide for load weight support. Room and access needs to be provided to allow for mounting the attachment assembly and for the person to be attached to the attachment assembly.

Nonlinear springs (viscous dampers and/or braking elements) with relatively low initial spring (damping and/or braking force) rates can be used. The spring (damper and/or braking elements) can start with lower relative rates and quickly adapt itself to the desired rates to achieve the desired rate of descent, etc. As a result, the system will not be very sensitive to the weight of the descending individual and can also absorb greater amount of kinetic/potential potential energy without the chance of a lighter weight person getting stuck along the way.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A device for decelerating a person during a descent, the device comprising:
an elongated member extending from a first elevated point to a second point below the first point in the direction of gravity; and
an attachment assembly movably attached to the elongated member and having the person disposed thereon;
wherein at least one of the elongated member and attachment assembly comprises a potential energy storage means for converting a kinetic energy of the attachment assembly into potential energy to thereby decelerate the attachment assembly and the person disposed thereon.

2. A method for decelerating a person during a descent, the method comprising:
extending an elongated member from a first elevated point to a second point below the first point in the direction of gravity;
movably attaching a person to the elongated member; and
converting a kinetic energy of the person into potential energy to thereby decelerate the person.
